(19) United States
(12) Patent Application Publication
(10) Pub. No.: US 2003/0193427 A1
(43) Pub. Date: Oct. 16, 2003

(54) Method for operating a portable hand-held transmitter for a remote-control system for a vehicle

(75) Inventors: Wolfram Schroeder, Ditzingen (DE); Jurgen Moczygemba, Lichtenstein (DE); Martin Lindmayer, Sulz (DE); Michael Geber, Bad Urach (DE)

Correspondence Address: CROWELL & MORING LLP, INTELLECTUAL PROPERTY GROUP, P.O. BOX 14300, WASHINGTON, DC, 20044-4300, US

(73) Assignee: Mercedes-Benz AG

(21) Appl. No.: 10/440,139

(22) Filed: May 19, 2003

Related U.S. Application Data
(63) Continuation of application No. 08/858,339, filed on May 19, 1997, now abandoned.

(30) Foreign Application Priority Data
May 17, 1996 (DE) 196 19 975.1

(51) Int. Cl. H04L 17/02; G08C 19/12

(52) U.S. Cl. 341/176; 340/825.72; 340/825.69

(57) ABSTRACT

The invention provides a method for operating a portable hand-held transmitter for a vehicle remote-control system in which a plurality of activation sequences control a plurality of assigned control functions in a normal operating mode, at least one control function being assigned to each prescribed activation sequence. The activation sequences differ in the manner and/or number of actuations of an activation mechanism of the portable transmitter. According to the invention the portable transmitter is switched over from the normal operating mode into a programming mode by means of a switch-over activation sequence which is carried out via the at least one activation mechanism. Assignments of the prescribed activation sequences and of the prescribed control functions can be changed as desired during the programming mode.

This application claims the priority of German priority document 196 19 975.1, the disclosure of which is expressly incorporated by reference herein.

### BACKGROUND AND SUMMARY OF THE INVENTION

The invention relates to a method for operating a portable hand-held transmitter for a vehicle remote-control system in which a plurality of control functions are activated by a plurality of activation sequences which are assigned thereto.

German patent document DE 38 30 511 C2 discloses a method for operating a central locking system in a motor vehicle, in which two prescribed activation sequences can be carried out as desired. A first activation sequence, characterized by a single turn of a key in a lock device, triggers a first control function which selectively unlocks only one closure associated with this lock device. A second activation sequence, characterized by a key being turned twice in the lock device, triggers a second control function, which globally unlocks all the closures of the central locking system. It may be considered a restriction on the operating convenience in this case that no remote-control device is provided for operating the central locking system.

German patent document DE 42 18 798 C2, discloses a generic remote-control device which comprises a portable hand-held transmitter with an activation mechanism, which can be used to implement two prescribed activation sequences. A first control function which unlocks a closure is triggered by means of a first activation sequence (a single actuation of the activation mechanism), while both the first prescribed control function and a second prescribed control function which supports the opening action of a hinged flap of a vehicle, are triggered by a second activation sequence, characterized by repeated actuation of the activation mechanism, in particular twice. One disadvantage of this arrangement is that the assignment of the prescribed activation sequences to the prescribed control functions is defined by the manufacturer during fabrication. That is, for specific prescribed control functions, for example selective/global unlocking of a central locking system disclosed in German patent document DE 38 30 511 C2 quoted above, a corresponding assignment by the manufacturer may have disadvantageous effects. Thus, if the activation sequence “single actuation of the activation mechanism” is assigned to the control function “selective unlocking of the central locking system” and if the activation sequence “repeated actuation of the activation mechanism” is assigned to the control function “global unlocking of the central locking system”, a user who predominantly uses the control function “global unlocking of the central locking system” has to accept a loss of convenience since he will always have to activate the activation mechanism repeatedly in order to trigger the control function which he uses predominantly.

In addition to activation sequences which are characterized by the number of actuations of an activation mechanism, the prior art also discloses other activation sequences for triggering different prescribed control functions with an activation mechanism. For example, German patent document DE 41 24 181 A1 describes a hand-held transmitter with an activation mechanism in which the prescribed activation sequences are characterized by different actuation intervals of the activation mechanism. Here, a first actuation interval is assigned a first prescribed control function which locks the closures of a central locking system, and a second actuation interval, which is longer than the first activation interval is assigned to the first prescribed control function and a second prescribed control function which provides a convenient way of closing a sunroof and/or vehicle windows. Here too, for the reasons mentioned above there may be a certain loss of convenience for a user since he has to activate the activation mechanism for a longer time period in order to trigger the second control function.

The object of the invention is to provide a method for operating a portable hand-held transmitter for a remote control system for a vehicle, which permits the operation of the hand-held transmitter to be adapted individually to the requirements of a user.

This object is achieved by the method according to the invention, which provides, in addition to a normal mode for triggering prescribed control functions, a separate programming mode by which an existing assignment of prescribed activation sequences to specific prescribed control functions can be changed as desired. That is by means of the programming mode, a user can adapt the existing assignment to his individual requirements.

Switch-over activation sequences are prescribed in order to distinguish clearly a selection of the programming mode from the prescribed activation sequences during the normal mode.

In a first prescribed switch-over activation sequence an activation mechanism is actuated for a specific actuation interval which is significantly longer than is necessary for triggering a prescribed control function in the normal mode. The prescribed activation sequences for triggering desired prescribed control functions in the normal mode are then distinguished in terms of the number of necessary actuations of the one activation mechanism. If a hand-held transmitter comprises more than one activation mechanism, the first prescribed switch-over activation sequence can be used to change only the assignments of one activation mechanism.

A second prescribed switch-over actuation sequence requires the simultaneous actuation of at least two activation mechanisms. This second prescribed switch-over activation sequence can be used to trigger a programming mode in which at least the assignments of the simultaneously actuated activation mechanism of the handheld transmitter can be changed.

With a hand-held transmitter, so that either the assignments of only one activation mechanism can be changed or the assignments of at least two activation mechanisms can be changed simultaneously, the transmitter has first and second switch-over activation sequences.

Of course, many other possibilities for the triggering of a programming mode are conceivable, for example by means of repeated simultaneous actuation of at least two activation mechanisms, by means of simultaneous actuation of at least two activation mechanisms for a specific actuation interval or by means of a specific sequence of actuation of at least two activation mechanisms etc.

Generally, a hand-held transmitter which comprises at least one activation mechanism can be used to trigger m control functions by means of n activation sequences, n and m being natural integers, in particular greater than 1. In order to change one or more prescribed assignments of the n activation sequences to the m control functions, a user carries out a switch-over activation sequence in order to select the programming mode. Then, a plurality of programming steps (for example, two) are carried out. In a first programming step, the activation sequence which is to be assigned to another control function is entered. This is effected for example by performing the activation sequence to which another prescribed control function is to be newly assigned. The other prescribed control function to which the prescribed activation sequence is to be newly assigned is entered as the second programming step, for example by performing the prescribed activation sequence which is hitherto assigned to this other prescribed control function. Of course, the sequence of entry can be interchanged. After the second programming step, the corresponding assignments are interchanged and the user has the option of changing further assignments or returning to the normal mode. By interchanging assignments, the triggering activation mechanism for a specific control function can also be changed. After return to the normal mode, the new assignments between the prescribed activation sequences and the prescribed control functions now form the basis for the normal mode.

The return to the normal mode can be effected either automatically after the expiration of a specific time interval following the last actuation of an activation mechanism or after the switch-over activation sequence has been carried out. In the latter case, the switch-over activation sequence fulfills two functions: on the one hand it activates the programming mode in normal mode and, on the other hand, it activates the normal mode in programming mode.

A simpler form of the programming mode can be used if in each case only two prescribed activation sequences can be carried out with a particular activation mechanism, in which case, in addition to the present assignment of the two activation sequences to the prescribed control functions, there is only one alternate form of such assignment. Thus, the programming mode for such an activation mechanism is composed of only the switch-over activation sequence. After that sequence is carried out, the assignments of the two prescribed activation sequences to the prescribed control functions are interchanged without further programming steps, and the hand-held transmitter returns to the normal mode when requested or automatically. If, for example before the switch-over activation sequence, a prescribed control function is assigned to a first prescribed activation sequence and another prescribed control function is assigned to a second prescribed activation sequence, after the switch-over activation sequence for this activation mechanism the control function which was previously assigned to the second activation sequence is newly assigned to the first activation sequence, and the control function which was previously assigned to the first activation sequence is newly assigned to the second activation sequence.

In an advantageous exemplary embodiment, the activation of the programming mode and/or the return to the normal mode is indicated by audible and/or visual indicator means, for example by means of a buzzer and/or by means of an LED. In addition, the entry of the programming steps may be confirmed by the aforesaid audible and/or visual indicator means.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a hand-held transmitter with an activation mechanism for remotely controlling control functions for a vehicle,

FIG. 2 is a schematic illustration of a hand-held transmitter with two activation mechanisms for remotely controlling control functions for a vehicle.

### DETAILED DESCRIPTION OF THE DRAWINGS

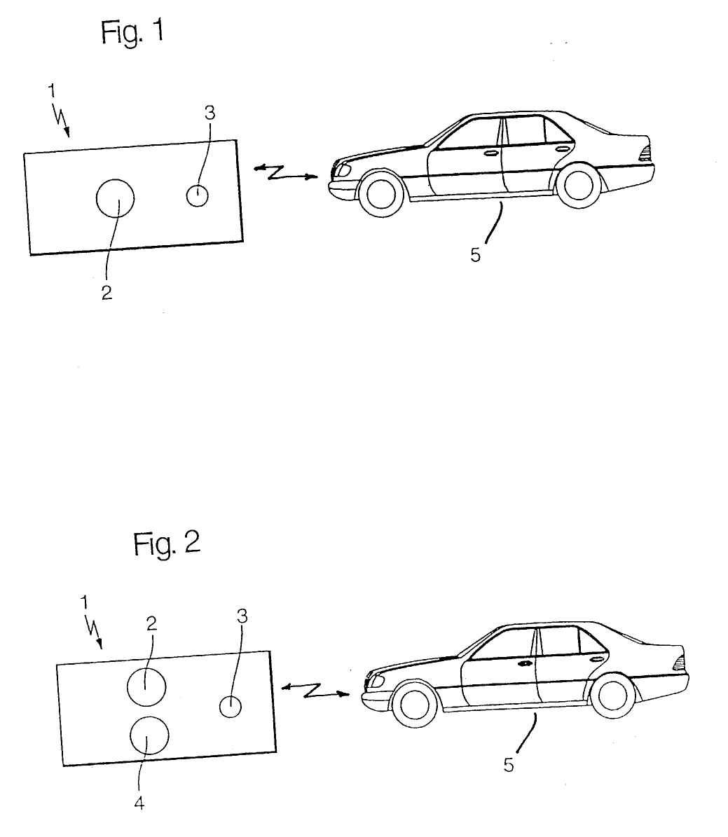

FIG. 1 shows a portable hand-held transmitter 1 with a first activation mechanism 2 (in the form of, for example, a tip switch) and an indicator 3 (for example, an LED), for remotely controlling control functions for a vehicle 5. Here, a first control function of the vehicle 5 is assigned to a first activation sequence, in which the activation mechanism 2 is actuated only once within a first time interval. A second control function is assigned to a second activation sequence in which the activation mechanism 2 is actuated twice within the first time interval, and a third control function is assigned to a third activation sequence in which the activation mechanism 2 is actuated three times within the first time interval. The previously described actuations of the activation mechanism 2 are characterized here by a first actuation interval. A switch-over activation sequence is characterized by single actuation of the first activation mechanism for a second actuation interval which is longer than the first actuation interval.

In order to explain the programming sequence, the third control function will now be newly assigned to the first activation sequence. This results in the following programming sequence:

The hand-held transmitter 1 is in the normal mode.

1. The programming mode is activated by carrying out the switch-over activation sequence (the activation mechanism 2 is actuated for the duration of the second activation interval). The indicator 3 then indicates by flashing repeatedly (for example, three times) that the hand-held transmitter 1 has activated the programming mode.

2. The first programming step is entered by carrying out the first activation sequence (single actuation of the activation mechanism 2). The indicator 3 confirms the first programming step by flashing repeatedly (for example, twice).

3. The second programming step is entered by carrying out the third activation sequence (actuation of the activation mechanism 2 three times). The indicator 3 confirms the second programming step by flashing repeatedly (for example, twice) and the hand-held transmitter interchanges the assignments. That is, the third control function is assigned to the first activation sequence and the first control function is assigned to the third activation sequence. The second activation sequence remains assigned to the second control function.

4. The system returns to the normal mode after the expiration of a second time interval following the last actuation of the activation mechanism 2. The indicator 3 indicates the return to the normal mode by flashing repeatedly (for example, three times).

FIG. 2 shows a hand-held transmitter 1 with a first activation mechanism 2, a second activation mechanism 4 and an indicator 3 (for example, an LED), for remotely controlling control functions for a vehicle 5. The two activation mechanisms are realized in this example as tip switches; however, any type of input device may be used. Here, a first control function is assigned to a first activation sequence in which the first activation mechanism 2 is actuated once within a first time interval. A second control function is assigned to a second activation sequence in which the first activation mechanism 2 is actuated twice within the first time interval. A third control function is assigned to a third activation sequence in which the second activation mechanism 4 is actuated once within the first time interval. A fourth control function is assigned to a fourth activation sequence in which the second activation mechanism 4 is actuated twice within the first time interval.

The previously described actuations of the two activation mechanism 2, 4 are characterized here by a first actuation interval. A first switch-over activation sequence is performed by a single actuation of the first activation mechanism 2 for the duration of a second actuation interval, which is longer than the first actuation interval. A second switch-over activation sequence is performed by a single actuation of the second activation mechanism 4 for the duration of the second actuation interval. A third switch-over activation sequence is performed by simultaneous actuation of the first and second activation mechanism 2, 4 for the duration of the first actuation interval.

Here, the first switch-over activation sequence selects a first programming mode for changing the assignments which relate to the first activation mechanism 2. The second switch-over activation sequence selects a second programming mode for changing the assignments which relate to the second activation mechanism 4. The third switch-over activation sequence selects a third programming mode for changing the assignments which relate to both activation mechanism 2, 4.

The third programming modes differs only in the manner of activation of the programming mode, which was described under FIG. 1. The first and the second programming modes differ from each other only in the manner of their activation. In order to explain the first and the second programming modes, the second prescribed control function will now be newly assigned to the first prescribed activation sequence. This is performed by means of the following programming sequence:

The hand-held transmitter 1 is in normal mode.

1. The first programming mode is activated by carrying out the first switch-over activation sequence (the first activation mechanism 2 is actuated for the duration of the second activation interval) The indicator 3 indicates, by flashing repeatedly (for example, three times) that the hand-held transmitter 1 has activated the programming mode.

2. The hand-held transmitter interchanges the assignments, i.e., the second control function is assigned to the first activation sequence, and the first control function is assigned to the second activation sequence. The assignment of the third activation sequence to the third control function, and the assignment of the fourth activation sequence to the fourth control function, remain unchanged.

3. The system returns to the normal mode after the expiration of a second time interval following the last actuation of the first activation mechanism 2. The indicator 3 indicates the return to the normal mode by flashing repeatedly (for example, three times).

In the described exemplary embodiments, only one control function is ever assigned to one activation sequence. Of course, one activation sequence may trigger a plurality of control functions, particularly in the case of control functions which are dependent on an order of events or on states. For example, a closure must be firstly unlocked before the supporting of an opening action can be triggered, or, depending on a state (closure locked/unlocked) either a first control function (unlocking of a closure), or a second control function (locking of a closure) is triggered.

In addition to the control functions already quoted, such as selective/global locking/unlocking of a closure, supporting of an opening action and a convenient way of closing a sunroof and/or vehicle windows, other control functions, for example for additional heating, anti-theft warning system, immobilizer etc., can also be conceived.

Although the invention has been described and illustrated in detail, it is to be clearly understood that the same is by way of illustration and example, and is not to be taken by way of limitation. The spirit and scope of the present invention are to be limited only by the terms of the appended claims.

What is claimed is:

1. Method of operating a portable hand-held transmitter for a vehicle remote-control system, which hand-held transmitter has at least one activation mechanism for generating a plurality of activation sequences-to control a plurality of control functions, at least one prescribed control function being assigned to each prescribed activation sequence, and, in a normal mode, the at least one activation mechanism triggering the assigned prescribed control functions by means of the prescribed activation sequences, wherein:
by means of at least one switch-over activation sequence which is carried out at the at least one activation mechanism, the portable hand-held transmitter is switched over from the normal mode into a programming mode wherein assignments of activation sequences to the control functions are changed.

2. Method according to claim 1 wherein the programming mode comprises at least two programming steps, a first activation sequence which is to be assigned to another control function being entered by means of a first programming step, and another control function to which the first activation sequence is to be newly assigned being entered in a second programming step.

3. Method according to claim 1 wherein the programming mode comprises at least two programming steps, a first control function which is to be assigned to another prescribed activation sequence being entered by means of a first programming step, and another activation sequence to which the first control function is to be newly assigned being entered in a second programming step.

4. Method according to claim 1 wherein:
two prescribed activation sequences can be carried out with said at least one activation mechanism, a first prescribed control function being assigned to a first prescribed activation sequence, and another prescribed control function being assigned to a second prescribed activation sequence; and
after a switch-over activation sequence, the prescribed control function which was previously assigned to the second prescribed activation sequence is newly assigned to the first prescribed activation sequence, and the prescribed control function which was previously assigned to the first prescribed activation sequence is newly assigned to the second prescribed activation sequence.

5. Method according to claim 1 wherein the portable hand-held transmitter is switched from the programming mode back to the normal mode by renewed execution of the at least one prescribed switch-over activation sequence.

6. Method according to claim 1 wherein after expiration of a specific time period following a last actuation of an activation mechanism, the portable handheld transmitter switches automatically from the programming mode to the normal mode.

7. Method according to claim 1 wherein the at least one switch-over activation sequence differs from activation sequences which trigger control functions, in a manner of actuation of the at least one activation mechanism.

8. Method according to claim 7 wherein the at least one prescribed switch-over activation sequence comprises a duration of actuation of the at least one activation mechanism which differs from that of the activation sequences for controlling control functions.

9. Method according to claim 7 wherein the at least one prescribed switch-over activation sequence comprises a simultaneous actuation of at least two activation mechanisms.

10. Method according to claim 1 wherein switching from the normal mode into the programming mode and from the programming mode into the normal mode is indicated by a visual and/or audible indicator.

11. Method according to claim 5 wherein switching from the normal mode into the programming mode and from the programming mode into the normal mode is indicated by a visual and/or audible indicator.

12. Method according to claim 6 wherein switching from the normal mode into the programming mode and from the programming mode into the normal mode is indicated by a visual and/or audible indicator.

13. Method of operating a vehicle remote-control system comprising a portable transmitter for controlling a plurality of remotely controllable vehicle subsystems, in a normal operating mode, by means of a plurality of activation sequences of said portable transmitter, at least one control function being assigned to each of said activation sequences, said method comprising the steps of:
providing a switch-over activation sequence of said portable transmitter;
carrying out said switch-over activation sequence at said portable transmitter;
in response to said switch-over activation sequence, said portable transmitter switching from said normal operating mode to a programming mode; and
in said programming mode, changing assignments of activation sequences to the respective control functions.

14. Method according to claim 13 wherein said step of changing assignments of activation sequences to respective control functions comprises said portable transmitter automatically interchanging assignments of first and second control functions to respective first and second activation sequences when said portable transmitter switches to said programming mode.

15. Method according to claim 13 wherein said step of changing assignments of activation sequences to respective control functions comprises the steps of:
entering information in said portable transmitter concerning particular control functions and activation sequences to be interchanged; and
said portable transmitter interchanging assignments of said particular control functions and activation sequences according to said information.

16. Method according to claim 13 wherein the programming mode comprises at least two programming steps, a first activation sequence which is to be assigned to another control function being entered by means of a first programming step, and another control function to which the first activation sequence is to be newly assigned being entered in a second programming step.

17. Method according to claim 13 wherein the programming mode comprises at least two programming steps, a first control function which is to be assigned to another prescribed activation sequence being entered by means of a first programming step, and another activation sequence to which the first control function is to be newly assigned being entered in a second programming step.

18. Method according to claim 13 wherein:
two prescribed activation sequences can be carried out with said at least one activation mechanism, a first prescribed control function is assigned to a first prescribed activation sequence, and another prescribed control function being assigned to a second prescribed activation sequence; and
after a switch-over activation sequence, the prescribed control function which was previously assigned to the second prescribed activation sequence is newly assigned to the first prescribed activation sequence, and the prescribed control function which was previously assigned to the first prescribed activation sequence is newly assigned to the second prescribed activation sequence.

19. Method according to claim 13 wherein the portable hand-held transmitter is switched from the programming mode back to the normal mode by renewed execution of the at least one prescribed switch-over activation sequence.

20. Method according to claim 13 wherein after expiration of a specific time period following a last actuation of an activation mechanism, the portable handheld transmitter switches automatically from the programming mode to the normal mode.
